(19) United States
(12) Patent Application Publication
(10) Pub. No.: US 2021/0116786 A1
(43) Pub. Date: Apr. 22, 2021

(54) IMAGING OPTICAL SYSTEM AND IMAGE PROJECTION APPARATUS HAVING THE SAME

(71) Applicant: CANON KABUSHIKI KAISHA, Tokyo (JP)

(72) Inventor: Shuichi Kurokawa, Saitama-shi (JP)

(21) Appl. No.: 17/066,646

(22) Filed: Oct. 9, 2020

(30) Foreign Application Priority Data
Oct. 17, 2019 (JP) 2019-190314

(51) Int. Cl. G03B 5/02; G02B 15/14; G02B 13/18; G03B 13/34

(52) U.S. Cl. CPC G03B 5/02; G02B 15/1421; G03B 2205/0046; G03B 13/34; G02B 13/18

(57) ABSTRACT

An imaging optical system includes, in order from an enlargement conjugate side to a reduction conjugate side, first and second optical systems both having positive refractive power. An enlargement conjugate point is imaged on an intermediate imaging position between the first and second optical systems. An image imaged on the intermediate imaging position is reimaged on a reduction conjugate point. The first optical system includes a first lens unit disposed closest to the enlargement conjugate side among lens units moving in an optical axis direction during focusing. The second optical system includes at least one lens unit fixed during focusing and moving in the optical axis direction during zooming. The first lens unit includes a meniscus lens disposed closest to the enlargement conjugate side and having a negative refractive power. The meniscus lens has an aspheric surface and is convex to the enlargement conjugate side.

### BACKGROUND OF THE INVENTION

### Field of the Invention

The present invention relates to an imaging optical system suitable for an image projection apparatus such as a projector that magnifies and projects an image displayed on a light modulation element.

### Description of the Related Art

In an image projection apparatus, a retrofocus type lens has been often used as a projection optical system to ensure a back focus and good telecentricity. Further, higher performance corresponding to a resolution exceeding full HD is required by high definition of the light modulation element and widening an angle of view is strongly desired to project a large image at a short distance.

In recent years, a zoom lens having a zooming function capable of changing a size of a projected image without changing a projection distance has been widely used as the projection optical system, and it is also important to have the zooming function while widening the angle of view. However, if the retrofocus type lens is used for widening the angle of view, the diameter of the lens disposed closest to a projection surface becomes extremely large. To prevent the lens disposed closest to the projection surface from increasing in diameter, a lens (hereinafter, a re-imaging type lens) has been proposed in which a display image of the light modulation element is once imaged as an intermediate image by a refractive optical system, and the intermediate image is magnified and projected on the projection surface by another refractive optical system. Japanese Patent Laid-Open No. (“JP”) 2018-36386 proposes a re-imaging type zoom lens having a zooming function with a compact focusing unit.

A large curvature of field occurs by widening the angle of view when the projection distance is changed, and thus it is necessary to correct the curvature of field during focusing. At that time, it is necessary to take care so that a distortion aberration does not change.

However, in the zoom lens of JP 2018-36386, it is possible to suppress changes in the angle of view due to focusing, but the curvature of field during focusing is not mentioned, and variations in the distortion aberration due to focusing may not be suppressed enough.

### SUMMARY OF THE INVENTION

The present invention provides an imaging optical system that can downsize a lens diameter while widening an angle of view and that has good optical performance over a wide projection distance range.

An imaging optical system according to one aspect of the present invention includes, in order from an enlargement conjugate side to a reduction conjugate side, a first optical system having a positive refractive power, and a second optical system having a positive refractive power. An enlargement conjugate point on the enlargement conjugate side is imaged on an intermediate imaging position between the first optical system and the second optical system. An image imaged on the intermediate imaging position is reimaged on a reduction conjugate point on the reduction conjugate side. The first optical system includes a first lens unit disposed closest to the enlargement conjugate side among lens units that moves in an optical axis direction of the imaging optical system during focusing. The second optical system includes at least one lens unit that is fixed during focusing and that moves in the optical axis direction during zooming. The first lens unit includes a meniscus lens that is disposed closest to the enlargement conjugate side and that has a negative refractive power. The meniscus lens has an aspheric surface. The meniscus lens is convex to the enlargement conjugate side.

Further features of the present invention will become apparent from the following description of exemplary embodiments with reference to the attached drawings.

### BRIEF DESCRIPTION OF THE DRAWINGS

FIG. 1 is an optical path diagram of an optical system according to a first embodiment at a wide-angle end.

FIG. 2 is an aberration diagram of the optical system according to the first embodiment.

FIG. 3 is an optical path diagram of an optical system according to a second embodiment at a wide-angle end.

FIG. 4 is an aberration diagram of the optical system according to the second embodiment.

FIG. 5 is an optical path diagram of an optical system according to a third embodiment at a wide-angle end.

FIG. 6 is an aberration diagram of the optical system according to the third embodiment.

FIG. 7 is an optical path diagram of an optical system according to a fourth embodiment at a wide-angle end.

FIG. 8 is an aberration diagram of the optical system according to the fourth embodiment.

FIG. 9 is an optical path diagram of an optical system according to a fifth embodiment at a wide-angle end.

FIG. 10 is an aberration diagram of the optical system according to the fifth embodiment.

FIG. 11 is a schematic diagram of an image projection apparatus of the present invention.

FIG. 12 is a schematic diagram of an image pickup apparatus of the present invention.

### DESCRIPTION OF THE EMBODIMENTS

Referring now to the accompanying drawings, a detailed description will be given of embodiments of the present invention. In each embodiment, corresponding elements will be designated by the same reference numerals and a description thereof will be omitted. In addition, in each drawing, in order to facilitate understanding of the present invention, it may be drawn at a different scale from an actual one.

### First Embodiment

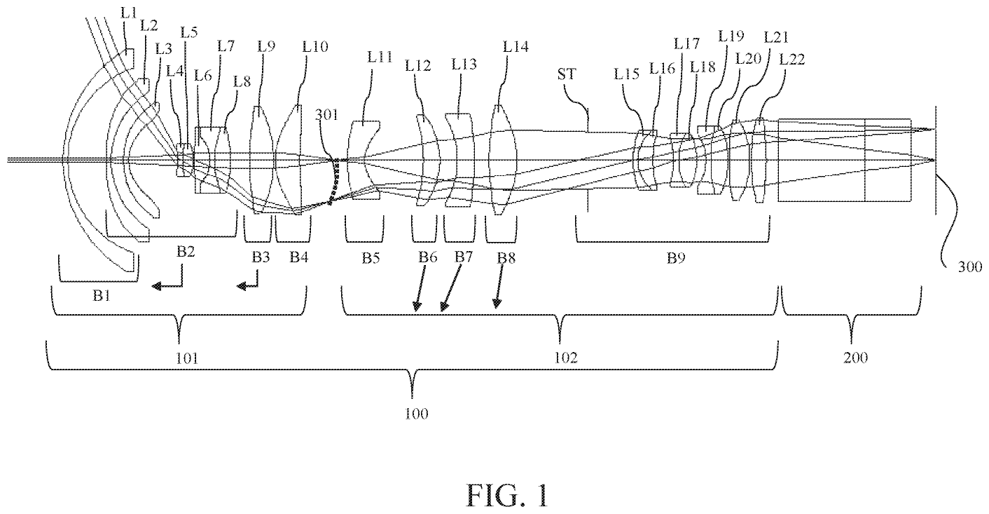

FIG. 1 is an optical path diagram of an optical system (imaging optical system) 100 according to this embodiment. The optical system 100 is a zoom lens having a zooming function, and FIG. 1 illustrates the optical path diagram at the wide-angle end at a projection distance of 655 mm.

In FIG. 1, the left side is an enlargement conjugate side and the right side is a reduction conjugate side. The optical system 100 includes, in order from the enlargement conjugate side to the reduction conjugate side, a first optical system having a positive refractive power, and a second optical system having a positive refractive power. Further, an enlargement conjugate point on the enlargement conjugate side is imaged on an intermediate imaging position between the first optical system and the second optical system, and an image imaged on the intermediate imaging position is reimaged on a reduction conjugate point on the reduction conjugate side.

The first optical system 101 includes, in order from the enlargement conjugate side to the reduction conjugate side, lens units B1, B2, B3, and B4 respectively having negative, negative, positive, and positive power. The second optical system 102 includes, in order from the enlargement conjugate side to the reduction conjugate side, lens units B5, B6, B7, B8, and B9 respectively having negative, positive, negative, positive, and positive power. ST is an aperture stop.

The second optical system 102 forms an intermediate image 301 which is a conjugate image of a light modulation element (image display element) 300, and the first optical system 101 projects the intermediate image 301 to a screen surface (projection surface) not illustrated. As the light modulation element 300, for example, a liquid crystal panel or a micromirror device is used.

A color combining optical system 200 is composed of a combining prism, and a PBS (polarizing beam splitter), etc., and is arranged between the optical system 100 and the light modulation element 300. The combining optical system 200 guides light modulated by the light modulation element 300 to the optical system 100.

In this embodiment, the screen surface is an enlargement side conjugate surface and the light modulation element 300 is a reduction side conjugate surface.

The first optical system 101 is responsible for widening an angle of view, and the second optical system 102 is responsible for ensuring a back focus and good telecentricity.

Additionally, a residual aberration of the second optical system 102 is corrected by the first optical system 101. With such a configuration, it is possible to realize good optical performance despite having a wide angle.

Further, the first optical system 101 is a retrofocus type lens and it is generally difficult to correct a distortion aberration, but the distortion aberration is corrected by disposing the lens unit B5 having a negative refractive power at the most enlargement conjugate side of the second optical system 102.

In addition, since the back focus of the first optical system 101, which is responsible for widening the angle of view, can be shortened as compared with a normal zoom lens having no intermediate image, a diameter of the lens disposed on the most enlargement conjugate side can be minimized.

In this embodiment, focusing when changing the projection distance is performed by changing a distance between some lens units (moving lens units) forming the first optical system 101. Specifically, focusing is performed by moving the lens units B2 and B3 in an optical axis direction of the first optical system 101 on different loci. The lens units B1 and B4 are fixed during focusing. The second optical system 102 is also fixed during focusing. The projection distance is a distance between the enlargement side conjugate surface and a lens surface on the enlargement conjugate side of a lens L1 which is disposed on the most enlargement conjugate side of the optical system 100.

Further, in this embodiment, zooming is performed by changing a distance between the lens units forming the second optical system 102. Specifically, zooming is performed by moving the lens units B6, B7, and B8 in an optical axis direction of the second optical system 102 on different loci. The aperture stop ST is a part of the lens unit B9 and does not move during zooming. In other words, the optical system 100 is a zoom lens that does not change the F number in accordance with zooming.

In this embodiment, by fixing the first optical system 101 during zooming, the optical effect is zooming of the intermediate image 301, and the configuration of the first optical system 101 can be simplified. Thus, as the back focus of the first optical system 101 can be shortened, the entire optical system 100 can be downsized. In addition, the lens units that move during zooming are integrated into the second optical system 102, and the zoom cam configuration can be also simplified.

In this embodiment, by fixing the second optical system 102 during focusing, the position of the intermediate image 301 hardly changes during focusing. Thus, the positions in the optical axis direction of the lens units B2 and B3 after focusing at the desired projection distance can be configured to be the same regardless of a zooming position of the second optical system 102. Accordingly, the configuration of the second optical system 102 can be simplified, and as a movement loci of the lens units B2 and B3 can be made the same regardless of the zoom position, the focus cam configuration can also be simplified.

In order for the wide-angle optical system 100 to have good optical performance over the wide projection distance as in this embodiment, it is necessary to satisfactorily correct a curvature of field, which is generated when the projection distance changes, during focusing. In this embodiment, disposing a meniscus lens L2 having a negative refractive power on the most enlargement conjugate side, where a height of an off-axis ray is large, among the lens units B2 and B3 moving during focusing can correct the curvature of field when focusing. In addition, disposing the meniscus lens L2 is also effective in suppressing variations in the distortion aberration.

Furthermore, the meniscus lens L2 is a lens having an aspherical surface. As the meniscus lens L2 has the aspherical surface, variations in the curvature of field and the distortion aberration can be more effectively suppressed.

Meanwhile, as the height of the off axis ray is large, a chromatic aberration of magnification changes in particular in accordance with a movement of the meniscus lens L2. In this embodiment, disposing the high dispersion lens unit B3 on the reduction conjugate side of the lens unit (first lens unit) B2 suppresses variations in the chromatic aberration of magnification. In this embodiment, when v is an Abbe number of the lens unit B3, the following conditional expression (1) may be satisfied.

0<v≤40 (1)

If the Abbe number is lower than the lower limit of the conditional expression (1), the lens units B2 and B3 to correct the chromatic aberration of magnification move in opposite direction, and thus it is necessary to widen the distance between the lens units 132 and 133 and the optical system 100 upsizes. If the Abbe number v is higher than the upper limit of the conditional expression (1), the dispersion of the lens unit 133 becomes weak and the effect of correcting the chromatic aberration becomes insufficient.

Preferably, the numerical range of the conditional expression (1) is set to the range of the following conditional expression (1a).

0<v≤30 (1a)

More preferably, the numerical range of the conditional expression (1) is set to the range of the following conditional expression (1b).

0<v≤25 (1b)

The lens unit B3 may include a single lens or a cemented lens. In this embodiment, a lens L9 included in the lens unit B3 is a single lens (first lens) and its Abbe number v is 22.76, which satisfies the conditional expression (1). When the lens L9 is configured by cementing n lenses, the Abbe number v is defined by the following equation (2). In the equation (2), f is a focal length of the lens L9, fᵢ is a focal length of the i-th single lens forming the lens L9, and vᵢ is an Abbe number of the i-th single lens.

$$v = \frac{1}{f {\sum }_{i = 1}^{n} \frac{1}{{f}_{i} {v}_{i}}} \qquad ( 2 )$$

In order to enhance the correction effect of the chromatic aberration of magnification, it is preferable to increase the height of off-axis rays to the lens L9. Further, in order to enhance the correction effect of the curvature of field, it is preferable to increase the height of the off-axis ray to the meniscus lens L2 disposed on the most enlargement conjugate side of the lens unit B2. In this embodiment, a pupil is disposed between the meniscus lens L2 and the lens L9, and a principal ray of the off-axis ray intersects the optical axis between the meniscus lens L2 and the lens L9. With such a configuration, the height of the off-axis ray with respect to the lens L9 can be increased, and the correction effect of the chromatic aberration of magnification can be enhanced.

When the power of the lens unit B3 is negative, the off-axis ray is refracted further outward, which causes an increase in the size of the optical system on the reduction conjugate side. Thus, it is preferable that the power of the lens unit B3 is positive.

Also, in order to suppress a movement amount of the lens units B2 and B3 during focusing to reduce the size of the optical system and to suppress variations in the chromatic aberration caused by the lens unit B2, the lens unit B2 preferably include a cemented lens. It is more preferable that the lens unit B2 has a cemented lens including three single lenses having a high chromatic aberration correction effect. In this embodiment, the lens unit B2 has a cemented lens including lenses L6, L7, and L8. It is especially preferable that the cemented lens includes, in order from the enlargement conjugate side to the reduction conjugate side, a biconvex lens, a biconcave lens, and a biconvex lens.

In order to enhance the chromatic aberration correction effect, when v₁₁, v₁₂, and v₁₃ are, in order from the enlargement conjugate side, Abbe numbers of the three single lenses forming the cemented lens, the following conditional expressions (3) and (5) may be satisfied.

v₁₂<v₁₁ (3)

v₁₂<v₁₃ (4)

v₁₁<v₁₃ (5)

In this embodiment, Abbe numbers of the lenses L6, L7, and L8 are 40.77, 23.78, and 68.62, which satisfy the conditional expressions (3) to (5).

When the focal lengths of the optical system from the meniscus lens L2 to the lens L9 (corresponding to the lens unit B2 in this embodiment) and the lens L9 are f₁ and f₂, respectively, the following conditional expression (6) may be satisfied.

$$- 1 ≦ \frac{{f}_{2}}{{f}_{1}} ≦ 1 \qquad ( 6 )$$

Outside the range of the conditional expression (6), the power of the lens L9 becomes too weaker than the absolute value of the power of the optical system from the meniscus lens L2 to the lens L9, and the chromatic aberration of magnification is insufficiently corrected.

In this embodiment, the focal length of the optical system from the meniscus lens L2 to the lens L9 and the focal length of the lens L9 are respectively −117.29 mm and 45.66 mm, and thus the conditional expression (6) is satisfied.

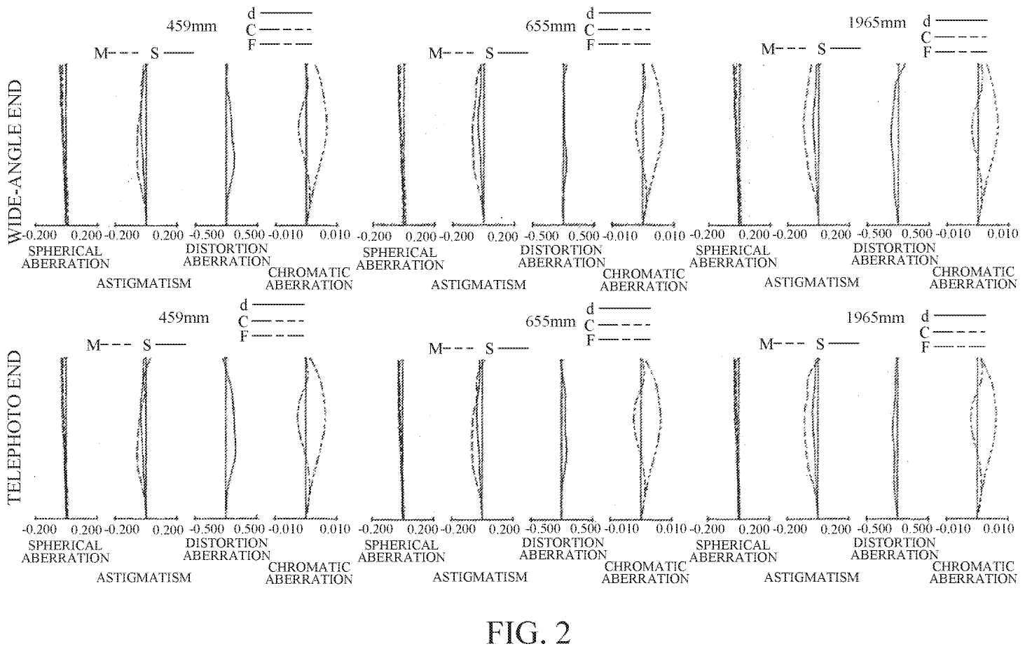

FIG. 2 is an aberration diagram of the optical system 100 at the wide-angle end and the telephoto end at the projection distances of 459 mm, 655 mm, and 1965 mm in this embodiment. In the aberration diagram of FIG. 2, the enlargement conjugate side is an object side, and the reduction conjugate side is an image side. The range of the horizontal axis is ±0.2 mm in a spherical aberration diagram and an astigmatism diagram, ±0.5% in a distortion aberration diagram, and ±0.01 mm in a chromatic aberration diagram.

In the spherical aberration diagram, spherical aberration amounts for the d-line, the C-line, and the F-line are illustrated. In the astigmatism diagram, M and S denote astigmatism in a meridional image plane and an astigmatism amount in a sagittal image plane, respectively. In the distortion aberration diagram, a distortion aberration amount for the d-line is illustrated. In the chromatic aberration diagram, chromatic aberration of magnification amounts for the C-line and the F-line are illustrated.

As illustrated in FIG. 2, all the aberrations are well corrected at both the wide-angle end and the telephoto end at each projection distance, and aberration variations due to focusing and zooming are also well suppressed.

As described above, the optical system 100 is a reimaging type zoom lens that includes the first optical system 101 disposed on the enlargement conjugate side than the intermediate image 301 and the second optical system 102 disposed on the reduction conjugate side than the intermediate image 301 and that has focusing and zooming functions. Focusing is performed by moving the lens units B2 and B3 among the plurality of lens units forming the first optical system 101 in the optical axis direction. Zooming is performed by moving the lens units B6, B7, and B8 among the plurality of lens units forming the second optical system 102 in the optical axis direction.

Fixing the first and second optical systems 101 and 102 during focusing and zooming to sandwich the intermediate image 301 hardly generates positional variations of the intermediate image 301 and can improve the optical performance while achieving miniaturization of the optical system. In addition, each moving unit and its locus during focusing can be the same regardless of the zoom position of the second optical system 102.

The lens unit B2 disposed on the most enlargement conjugate side of the two lens units moving during focusing has the meniscus lens L2 having the negative refractive power on the most enlargement conjugate side. Further, the lens unit 93 disposed on the reduction conjugate side of the lens unit B2 has the high dispersion lens L9.

With such a configuration, it is possible to provide the optical system 100 that can downsize the lens diameter while widening the angle of view and that has good optical performance over the wide projection distance range.

In this embodiment, the first optical system 101 includes four lens units, but the present invention is not limited to this. The first optical system 101 may include a different number of lens units. Also, regarding the second optical system 102, the number of units and the configuration of each unit can be changed as appropriate.

Further, in this embodiment, the optical system 100 is an optical system used in the image projection apparatus, but by changing the color combining optical system 200 and replacing the light modulation element 300 with a CCD sensor or a CMOS sensor, can also be used as an imaging optical system.

The back focus can be also changed according to the intended use.

### Second Embodiment

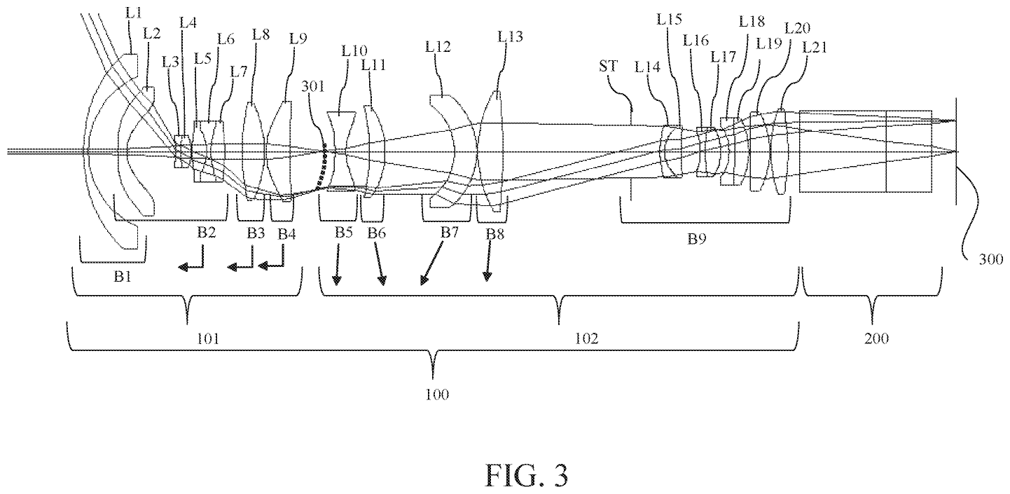

FIG. 3 is an optical path diagram of an optical system 100 according to this embodiment. The optical system 100 is a zoom lens having a zooming function, and FIG. 3 illustrates the optical path diagram at the wide-angle end at the projection distance of 775 mm.

The positive and negative power arrangement of each lens unit and the number of lens units forming a first optical system 101 and a second optical system 102 are the same as those in the first embodiment, but the number of single lenses forming each lens unit is partially different.

In this embodiment, the number of lens units that move during focusing is increased by one as compared with the first embodiment, and it is possible to better correct variations in a curvature of field.

Also, the number of lens units that moves during zooming is increased by one to achieve high zooming while improving correction of aberration variations during zooming.

In this embodiment, focusing is performed by moving the lens units B2, B3, and B4 of the first optical system 101 in an optical axis direction on different loci. A lens unit B1 is fixed during focusing.

In the first optical system 101, the lens unit (first lens unit) B2 among the lens units that move during focusing includes a meniscus lens L2 having a negative refractive power on the most enlargement conjugate side. The meniscus lens L2 has an aspherical surface.

In this embodiment, the lens unit B3 disposed on the most reduction conjugate side of the lens unit B2 is formed by a lens (first lens) L8 that is a high dispersion single lens. An Abbe number v of the lens L8 is 22.76, which satisfies the conditional expression (1). Thus, the chromatic aberration of magnification can be corrected well.

Same as the first embodiment, disposing the pupil between the meniscus lens L2 and the lens L8 increases the height of the off-axis ray with respect to the lens L8 and the power of the lens unit B3 is positive in order to suppress the enlargement of the optical system on the reduction conjugate side.

In this embodiment, moving the lens unit B4 during focusing can better correct the variations in the curvature of field.

As changing the wide-angle end of the optical system 100 toward wider-angle side generates the larger the curvature of field when the projection distance changes, the number of the lens units that move during focusing is preferably three like in this embodiment especially when the half angle of view exceeds 60°.

Further, in order to suppress an increase in size of the optical system on the reduction conjugate side, the power of the lens unit B4 is preferably positive.

In this embodiment, zooming is performed by moving the lens units B5, B6, B7, and B8 forming the second optical system 102 in an optical axis direction of the second optical system 102 on different loci. An aperture stop ST is a part of a lens unit B9 and does not move during zooming. That is, the optical system 100 is a zoom lens that does not change the F number in accordance with zooming.

In this embodiment, the focal length of the optical system from the meniscus lens L2 to the lens L8 and the focal length of the lens L8 are respectively −146.45 mm and 40.91 mm, and thus the conditional expression (6) is satisfied.

In this embodiment, the lens unit B2 includes a cemented lens having a biconvex lens L5, a biconcave lens L6, and a biconvex lens L7. Abbe numbers of the biconvex lens L5, the biconcave lens L6, and the biconvex lens L7 are 46.62, 23.78, and 68.62, which satisfy the conditional expressions (3) to (5).

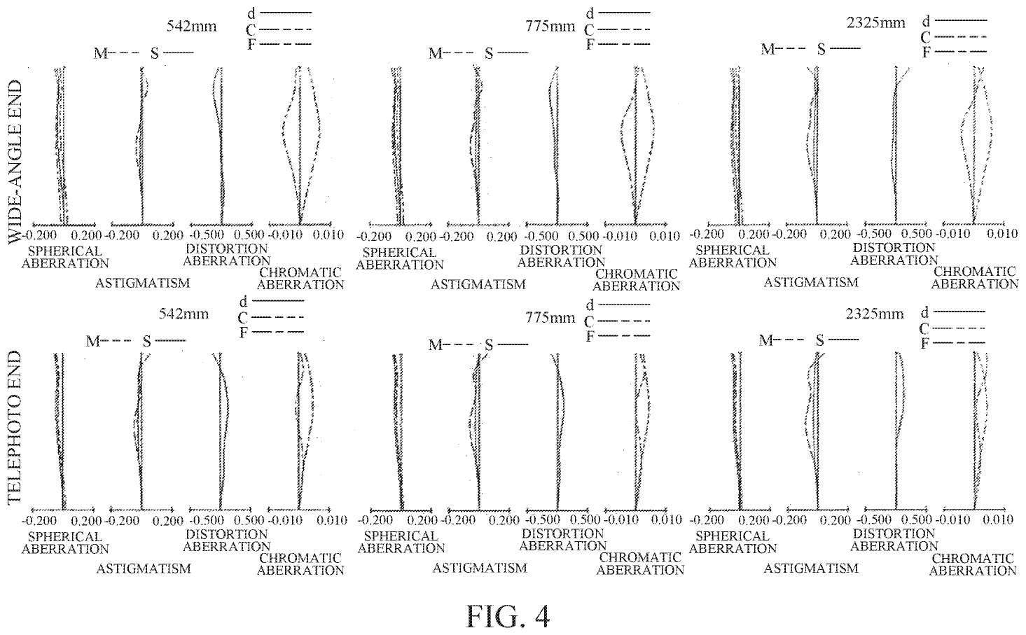

FIG. 4 is an aberration diagram of the optical system 100 at the wide-angle end and the telephoto end at the projection distances of 542 mm, 775 mm, and 2325 mm in this embodiment. All the aberrations are well corrected at both the wide-angle end and the telephoto end at each projection distance, and aberration variations due to focusing and zooming are also well suppressed.

As described above, the optical system 100 is a reimaging type zoom lens that includes the first optical system 101 disposed on the enlargement conjugate side than an intermediate image 301 and the second optical system 102 disposed on the reduction conjugate side than the intermediate image 301 and that has focusing and zooming functions. Focusing is performed by moving the lens units B2, B3, and B4 among the plurality of lens units forming the first optical system 101 in the optical axis direction. Zooming is performed by moving the lens units B5, B6, B7, and B8 among the plurality of lens units forming the second optical system 102 in the optical axis direction.

Fixing the first and second optical systems 101 and 102 during focusing and zooming to sandwich the intermediate image 301 hardly generates positional variations of the intermediate image 301 and can improve the optical performance while achieving miniaturization of the optical system. In addition, each moving unit and its locus during focusing can be the same regardless of the zoom position of the second optical system 102.

The lens unit B2 disposed on the most enlargement conjugate side among the three lens units moving during focusing has the meniscus lens L2 having a negative refractive power on the most enlargement conjugate side. Further, the lens unit B3 disposed on the reduction conjugate side of the lens unit B2 has the high dispersion lens L8.

With such a configuration, it is possible to provide the optical system 100 that can downsize the lens diameter while widening the angle of view and that has good optical performance over the wide projection distance range.

### Third Embodiment

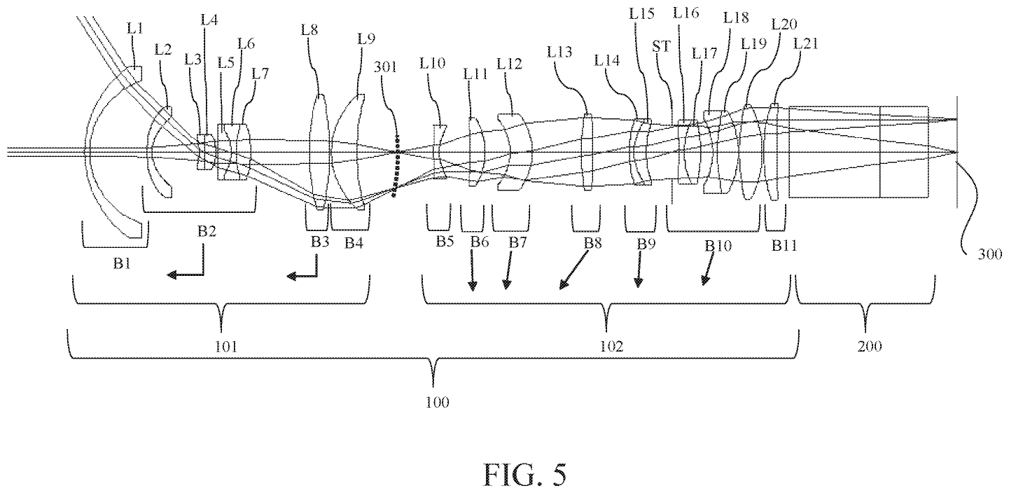

FIG. 5 is an optical path diagram of an optical system 100 according to this embodiment. The optical system 100 is a zoom lens having a zooming function, and FIG. 5 illustrates the optical path diagram at the wide-angle end at the projection distance of 1163 mm.

The optical system 100 includes, in order from the enlargement conjugate side to the reduction conjugate side, a first optical system 101 that makes the enlargement side conjugate surface and the intermediate image conjugate and that has a positive refractive power, and a second optical system 102 that makes the intermediate image and the reduction side conjugate surface conjugate and that has a positive retractive power.

The first optical system 101 includes, in order from the enlargement conjugate side to the reduction conjugate side, lens units B1, B2, B3, and B4 respectively having negative, positive, positive, and positive power. The second optical system 102 includes, in order from the enlargement conjugate side to the reduction conjugate side, lens units B5, B6, B7, B8, B9, B10, and B11 respectively having negative, positive, negative, positive, negative, positive, and positive power. ST is an aperture stop.

In this embodiment, focusing is performed by moving the lens units B2 and B3 of the first optical system 101 in an optical axis direction on different loci. The lens units B1 and B4 are fixed during focusing.

In the first optical system 101, the lens unit (first lens unit) B2 of the lens units that move during focusing includes a meniscus lens L2 having a negative refractive power on the most enlargement conjugate side. The meniscus lens L2 has an aspherical surface.

In this embodiment, the lens unit B3 disposed on the most reduction conjugate side of the lens unit B2 is formed by a lens (first lens) L8 that is a high dispersion single lens. An Abbe number v of the lens L8 is 22.76, which satisfies the conditional expression (1). Thus, the chromatic aberration of magnification can be corrected well.

Same as the first and second embodiments, disposing the pupil between the meniscus lens L2 and the lens L8 increases the height of the off-axis ray with respect to the lens L8 and the power of the lens unit B3 is positive in order to suppress the enlargement of the optical system on the reduction conjugate side.

In this embodiment, zooming is performed by moving the lens units B6, B7, B8, B9, and B10 forming the second optical system 102 in an optical axis direction of the second optical system 102 on different loci. An aperture stop ST is a part of the lens unit 310 and moves during zooming. That is, the optical system 100 is a zoom lens that changes the F number in accordance with zooming.

In this embodiment, the focal length of the optical system from the meniscus lens L2 to the lens L8 and the focal length of the lens L8 are respectively 142.72 mm and 64.41 mm, and thus the conditional expression (6) is satisfied.

In this embodiment, the lens unit B2 includes a cemented lens having a biconvex lens L5, a biconcave lens L6, and a biconvex lens L7. Abbe numbers of the biconvex lens L5, the biconcave lens L6, and the biconvex lens L7 are 37.13, 23.78, and 68.62, which satisfy the conditional expressions (3) to (5).

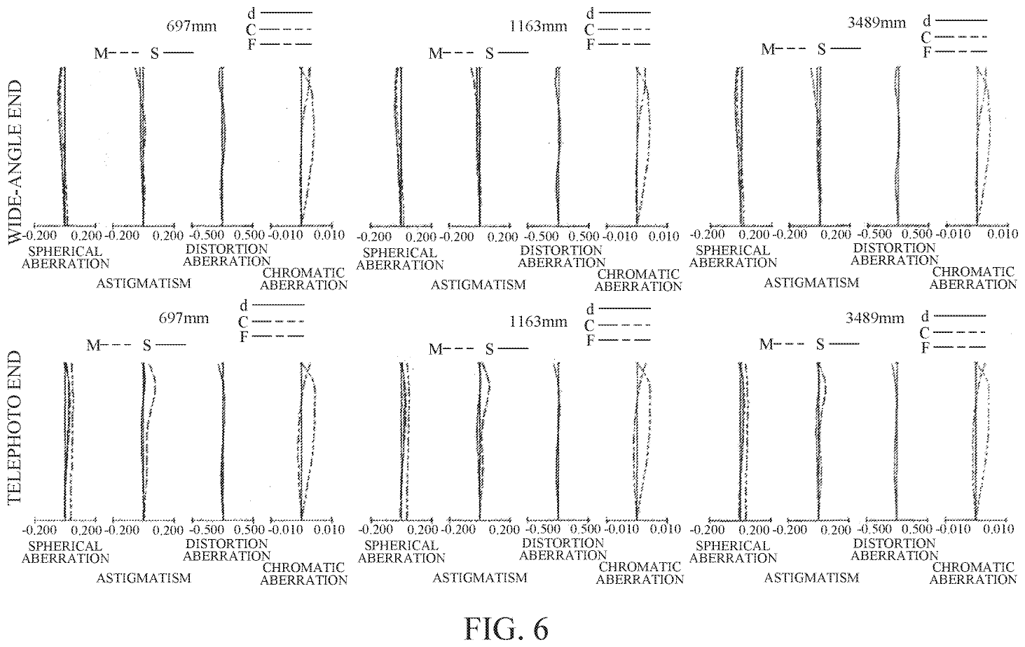

FIG. 6 is an aberration diagram of the optical system 100 at the wide-angle end and the telephoto end at the projection distances of 697 mm, 1163 mm, and 3489 mm in this embodiment. All the aberrations are well corrected at both the wide-angle end and the telephoto end at each projection distance, and aberration variations due to focusing and zooming are also well suppressed.

As described above, the optical system 100 is a reimaging type zoom lens that includes the first optical system 101 disposed on the enlargement conjugate side than an intermediate image 301 and the second optical system 102 disposed on the reduction conjugate side than the intermediate image 301 and that has focusing and zooming functions. Focusing is performed by moving the lens units B2 and B3 among the plurality of lens units forming the first optical system 101 in the optical axis direction. Zooming is performed by moving the lens units B6, B7, B8, B9, and B10 among the plurality of lens units forming the second optical system 102 in the optical axis direction.

Fixing the first and second optical systems 101 and 102 during focusing and zooming to sandwich the intermediate image 301 hardly generates positional variations of the intermediate image 301 and can improve the optical performance while achieving miniaturization of the optical system. In addition, each moving unit and its locus during focusing can be the same regardless of the zoom position of the second optical system 102.

The lens unit B2 disposed on the most enlargement conjugate side of the two lens units moving during focusing has the meniscus lens L2 having the negative refractive power on the most enlargement conjugate side. Further, the lens unit B3 disposed on the reduction conjugate side of the lens unit B2 has the high dispersion lens L8.

With such a configuration, it is possible to provide the optical system 100 that can downsize the lens diameter while widening the angle of view and that has good optical performance over the wide projection distance range.

### Fourth Embodiment

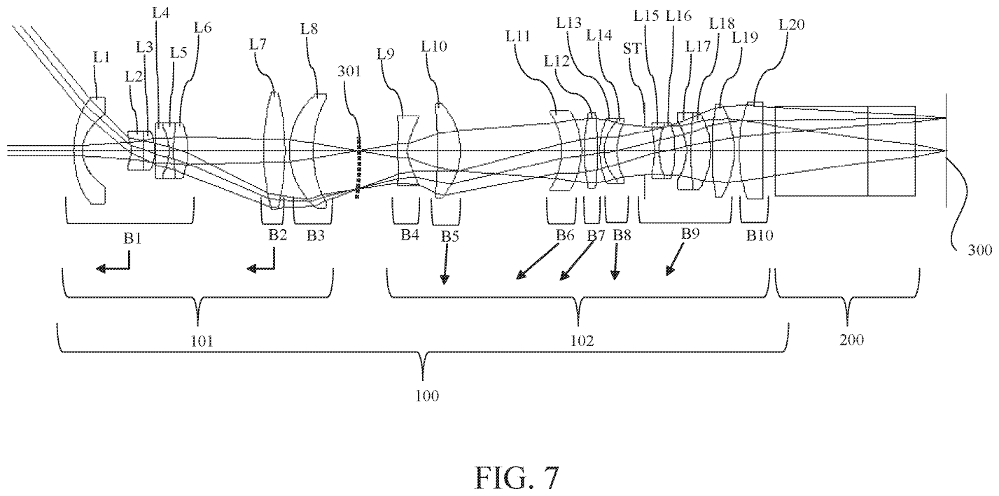

FIG. 7 is an optical path diagram of an optical system 100 according to this embodiment. The optical system 100 is a zoom lens having a zooming function, and FIG. 7 illustrates the optical path diagram at the wide-angle end at the projection distance of 1463 mm.

The optical system 100 includes, in order from the enlargement conjugate side to the reduction conjugate side, a first optical system 101 that makes the enlargement side conjugate surface and the intermediate image conjugate and that has a positive refractive power, and a second optical system 102 that makes the intermediate image and the reduction side conjugate surface conjugate and that has a positive refractive power.

The first optical system 101 includes, in order from the enlargement conjugate side to the reduction conjugate side, lens units B1, B2, and B3 respectively having positive, positive, and positive power. The second optical system 102 includes, in order from the enlargement conjugate side to the reduction conjugate side, lens units B4, B5, B6, B7, B8, B9, and B10 respectively having negative, positive, negative, positive, negative, positive, and positive power. ST is an aperture stop.

In this embodiment, focusing is performed by moving the lens units B1 and B2 of the first optical system 101 in an optical axis direction on different loci. The lens units B3 is fixed during focusing.

In the first optical system 101, the lens unit (first lens unit) B1 of the lens units that move during focusing includes a meniscus lens L1 having a negative refractive power on the most enlargement conjugate side. The meniscus lens L2 has an aspherical surface.

In this embodiment, the lens unit B2 disposed on the most reduction conjugate side of the lens unit B1 is formed by a lens (first lens) L7 that is a high dispersion single lens. An Abbe number v of the lens L7 is 22.76, which satisfies the conditional expression (1). Thus, the chromatic aberration of magnification can be corrected well.

Same as the first to third embodiments, disposing the pupil between the meniscus lens L2 and the lens L7 increases the height of the off-axis ray with respect to the lens L7 and the power of the lens unit B3 is positive in order to suppress the enlargement of the optical system on the reduction conjugate side.

In this embodiment, zooming is performed by moving the lens units B5, B6, B7, B8, and B9 forming the second optical system 102 in an optical axis direction of the second optical system 102 on different loci. An aperture stop ST is a part of the lens unit B9 and moves during zooming. That is, the optical system 100 is a zoom lens that changes the F number in accordance with zooming.

In this embodiment, the focal length of the optical system from the meniscus lens L2 to the lens L7 and the focal length of the lens L7 are respectively 95.83 mm and 62.19 mm, and thus the conditional expression (6) is satisfied.

In this embodiment, the lens unit B1 includes a cemented lens having a biconvex lens L4, a biconcave lens L5, and a biconvex lens L6. Abbe numbers of the biconvex lens L4, the biconcave lens L5, and the biconvex lens L6 are 40.77, 23.78, and 68.62, which satisfy the conditional expressions (3) to (5).

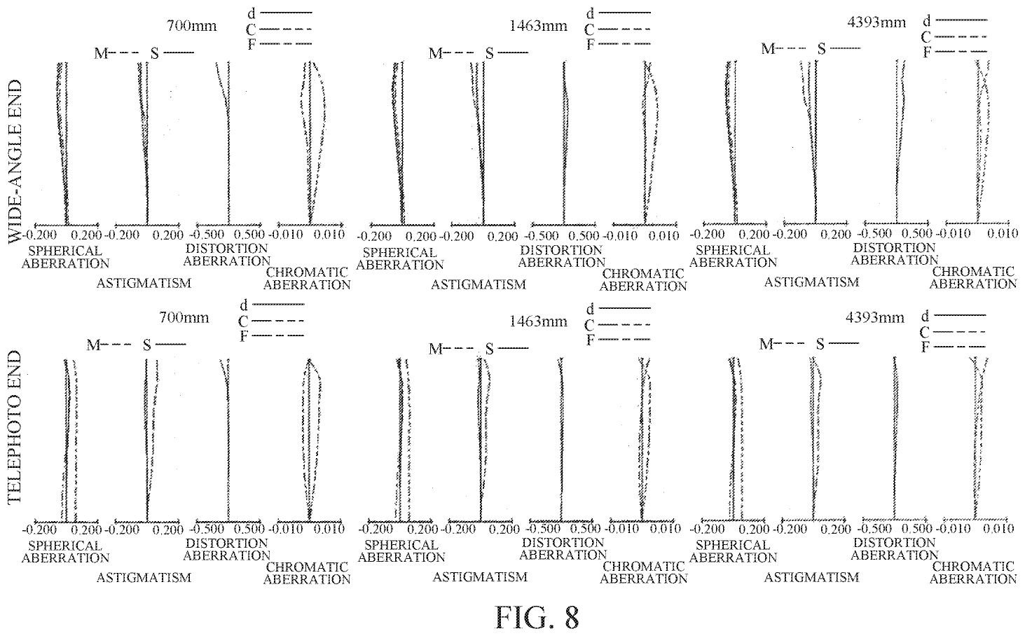

FIG. 8 is an aberration diagram of the optical system 100 at the wide-angle end and the telephoto end at the projection distances of 700 mm, 1463 mm, and 4393 mm in this embodiment. All the aberrations are well corrected at both the wide-angle end and the telephoto end at each projection distance, and aberration variations due to focusing and zooming are also well suppressed.

As described above, the optical system 100 is a reimaging type zoom lens that includes the first optical system 101 disposed on the enlargement conjugate side than an intermediate image 301 and the second optical system 102 disposed on the reduction conjugate side than the intermediate image 301 and that has focusing and zooming functions. Focusing is performed by moving the lens units B1 and B2 among the plurality of lens units forming the first optical system 101 in the optical axis direction. Zooming is performed by moving the lens units B5, B6, B7, B8, and B9 among the plurality of lens units forming the second optical system 102 in the optical axis direction.

Fixing the first and second optical systems 101 and 102 during focusing and zooming to sandwich the intermediate image 301 hardly generates positional variations of the intermediate image 301 and can improve the optical performance while achieving miniaturization of the optical system. In addition, each moving unit and its locus during focusing can be the same regardless of the zoom position of the second optical system 102.

The lens unit B1 disposed on the most enlargement conjugate side of the two lens units moving during focusing has the meniscus lens L2 having the negative refractive power on the most enlargement conjugate side. Further, the lens unit B2 disposed on the reduction conjugate side of the lens unit B3 has the high dispersion lens L7.

With such a configuration, it is possible to provide the optical system 100 that can downsize the lens diameter while widening the angle of view and that has good optical performance over the wide projection distance range.

### Fifth Embodiment

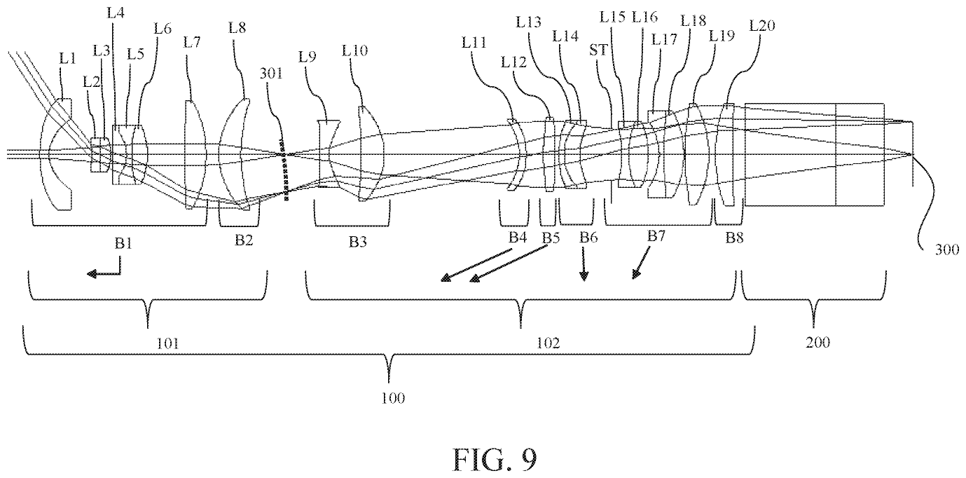

FIG. 9 is an optical path diagram of an optical system 100 according to this embodiment. The optical system 100 is a zoom lens having a zooming function, and FIG. 9 illustrates the optical path diagram at the wide-angle end at the projection distance of 1163 mm.

The optical system 100 includes, in order from the enlargement conjugate side to the reduction conjugate side, a first optical system 101 that makes the enlargement side conjugate surface and the intermediate image conjugate and that has a positive refractive power, and a second optical system 102 that makes the intermediate image and the reduction side conjugate surface conjugate and that has a positive retractive power.

The first optical system 101 includes, in order from the enlargement conjugate side to the reduction conjugate side, lens units B1 and B2 respectively having positive, and positive power. The second optical system 102 includes, in order from the enlargement conjugate side to the reduction conjugate side, lens units B3, B4, B5, B6, B7, and B8 respectively having positive, negative, positive, positive, positive, and positive power. ST is an aperture stop.

In this embodiment, focusing is performed by moving the lens unit B1 of the first optical system 101 in an optical axis direction on different loci. The lens unit B2 is fixed during focusing.

The lens unit (first lens unit) B1 includes a meniscus lens L1 having a negative refractive power on the most enlargement conjugate side. The meniscus lens L1 has an aspherical surface.

In this embodiment, the lens unit B1 includes a lens L7 that is a high dispersion single lens on the most reduction conjugate side. That is, in this embodiment, unlike the other embodiments, the lens unit B1 having the meniscus lens L1 includes the high dispersion lens (first lens) L7. An Abbe number v of the lens L7 is 22.76, which satisfies the conditional expression (1). Thus, the chromatic aberration of magnification can be corrected well.

Same as the first to fourth embodiments, disposing the pupil between the meniscus lens L1 and the lens L7 increases the height of the off-axis ray with respect to the lens L7 and the power of the lens B7 is positive in order to suppress the enlargement of the optical system on the reduction conjugate side.

In this embodiment, zooming is performed by moving the lens units B4, B5, B6, and B7 forming the second optical system 102 in an optical axis direction of the second optical system 102 on different loci. An aperture stop ST is a part of the lens unit B7 and moves during zooming. That is, the optical system 100 is a zoom lens that changes the F number in accordance with zooming.

In this embodiment, the focal length of the optical system from the meniscus lens L2 to the lens L7 and the focal length of the lens L7 are respectively −312.48 mm and 51.51 mm, and thus the conditional expression (6) is satisfied.

In this embodiment, the lens unit B1 includes a cemented lens having a biconvex lens L4, a biconcave lens L5, and a biconvex lens L6. Abbe numbers of the biconvex lens L4, the biconcave lens L5, and the biconvex lens L6 are 46.62, 24.80, and 67.74, which satisfy the conditional expressions (3) to (5).

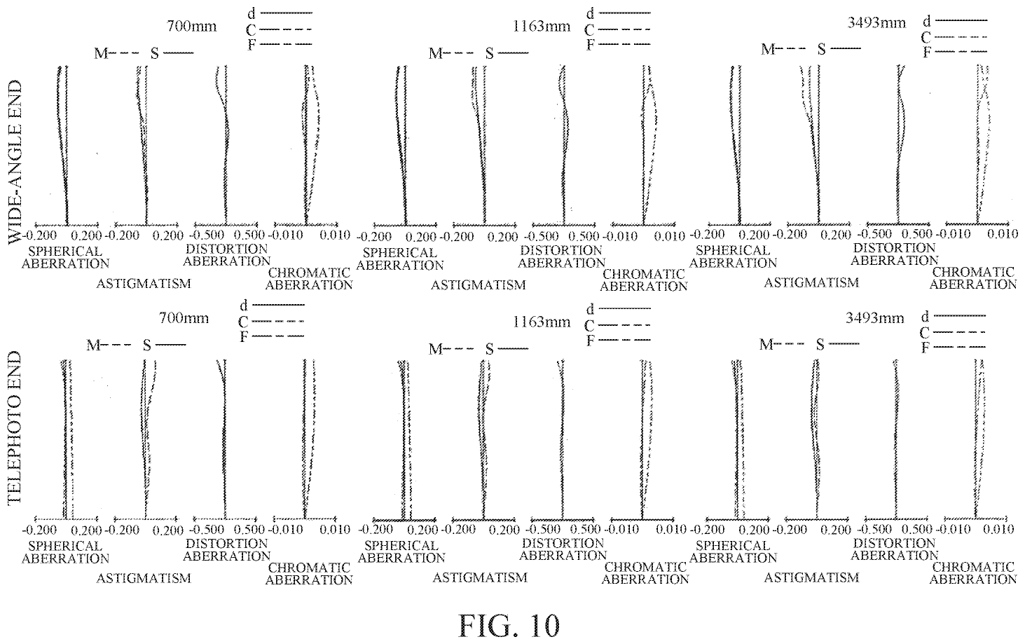

FIG. 10 is an aberration diagram of the optical system 100 at the wide-angle end and the telephoto end at the projection distances of 700 mm, 1163 mm, and 3493 mm in this embodiment. All the aberrations are well corrected at both the wide-angle end and the telephoto end at each projection distance, and aberration variations due to focusing and zooming are also well suppressed.

As described above, the optical system 100 is a reimaging type zoom lens that includes the first optical system 101 disposed on the enlargement conjugate side than an intermediate image 301 and the second optical system 102 disposed on the reduction conjugate side than the intermediate image 301 and that has focusing and zooming functions. Focusing is performed by moving the lens unit B1 of the plurality of lens units forming the first optical system 101 in the optical axis direction. Zooming is performed by moving the lens units B4, B5, B6, and B7 among the plurality of lens units forming the second optical system 102 in the optical axis direction.

Fixing the first and second optical systems 101 and 102 during focusing and zooming to sandwich the intermediate image 301 hardly generates positional variations of the intermediate image 301 and can improve the optical performance while achieving miniaturization of the optical system. In addition, each moving unit and its locus during focusing can be the same regardless of the zoom position of the second optical system 102.

The lens unit B1 disposed on the most enlargement conjugate side of the two lens units moving during focusing has the meniscus lens L2 having the negative refractive power on the most enlargement conjugate side. Further, the lens unit B1 has the high dispersion lens L7 on the most reduction conjugate side.

With such a configuration, it is possible to provide the optical system 100 that can downsize the lens diameter while widening the angle of view and that has good optical performance over the wide projection distance range.

Tables 1 to 5 show specific numerical data of the optical system 100 according to the first to fifth embodiments.

Each table (A) shows the lens configuration. f is the focal length, Fno is the F number, and ω is the half angle of view (degree). The sign of the focal length is negative, but because an intermediate image is formed, erect images are imaged on the enlargement side conjugate surface and the reduction side conjugate surface, and the optical system 100 has a positive power.

In addition, a paraxial curvature radius r is a radius of curvature of each surface, a surface interval d is an axial distance between each surface and an adjacent surface, a refractive index n and an Abbe number v are respectively a refractive index and an Abbe number of a material of each optical member for the d-line. The Abbe number v of a certain material is expressed as follows where Nd, NF, and NC are the refractive indices for the d-line (587.6 nm), the F-line (486.1 nm), and the C-line (656.3 nm) of the Fraunhofer line:

v=(Nd−1)/(NF−NC)

Further, when the optical surface is an aspherical surface represented by the following expression (7), the symbol * is attached to the left side of a surface number. y is a radial distance from the optical axis, z is a sag amount of the surface in the optical axis direction, r is the paraxial curvature radius, and k is a conic coefficient. The sign of z in the direction from the enlargement conjugate side to the reduction conjugate side is positive. Additionally, ST denotes the aperture stop.

$$z = \frac{\frac{{y}^{2}}{r}}{1 + \sqrt{1 - ( 1 + k ) {( \frac{y}{r} )}^{2}}} + {\sum }_{j = 1}^{16} {B}_{j} {y}^{j} \qquad ( 7 )$$

Each Table (B) shows the coefficient of each surface. “E±x” means “10^{±x}”.

Each Table (C) shows each surface interval (unit interval) that changes during focusing and zooming. The distance L is the projection distance.

TABLE 1
(A)

| | | Wide-Angle End | | Telephoto End | |
|---|---|---|---|---|---|
| f | | −4.89 | | −5.19 | |
| Fno | | 2.40 | | 2.40 | |
| ω | | 69.35 | | 68.43 | |
| Zoom Ratio | | 1.05 | | | |
| | Surface | Paraxial Curvature | Surface Interval | Refractive | Abbe |
| | Number | Radius r[mm] | d[mm] | Index n | Number ν |
| | 1 | 55.35 | 2.000 | 1.892 | 37.13 |
| | 2 | 42.00 | Variable | — | — |
| ※ | 3 | 149.35 | 1.870 | 1.772 | 49.60 |
| | 4 | 34.58 | 5.379 | — | — |
| ※ | 5 | 35.19 | 2.000 | 1.583 | 59.39 |
| ※ | 6 | 14.72 | 21.153 | — | — |
| | 7 | −33.13 | 2.000 | 1.847 | 23.78 |
| | 8 | 26.78 | 4.472 | 1.593 | 68.62 |
| | 9 | −20.99 | 0.500 | — | — |
| | 10 | 125.93 | 6.716 | 1.883 | 40.77 |
| | 11 | −13.91 | 2.000 | 1.847 | 23.78 |
| | 12 | 36.71 | 6.669 | 1.593 | 68.62 |
| | 13 | −50.56 | Variable | — | — |
| | 14 | 132.90 | 10.079 | 1.808 | 22.76 |
| | 15 | −49.97 | Variable | — | — |
| ※ | 16 | 27.65 | 10.377 | 1.861 | 37.10 |
| ※ | 17 | 184.46 | 20.332 | — | — |
| ※ | 18 | 57.12 | 7.388 | 1.808 | 40.55 |
| ※ | 19 | 12.04 | Variable | — | — |
| | 20 | −59.53 | 7.003 | 1.916 | 31.60 |
| | 21 | −31.72 | Variable | — | — |
| | 22 | −34.31 | 7.296 | 1.764 | 48.49 |
| | 23 | −105.86 | Variable | — | — |
| | 24 | 117.74 | 11.627 | 1.583 | 59.39 |
| ※ | 25 | −39.68 | Variable | — | — |
| ST | 26 | ∞ | 19.332 | — | — |
| | 27 | 35.09 | 2.000 | 1.652 | 58.55 |
| | 28 | 15.57 | 6.404 | 1.808 | 22.76 |
| | 29 | 38.01 | 8.585 | — | — |
| | 30 | −49.86 | 2.551 | 1.847 | 23.78 |
| | 31 | 24.19 | 7.725 | 1.603 | 60.64 |
| | 32 | −23.90 | 3.829 | — | — |
| | 33 | −19.04 | 2.000 | 1.916 | 31.60 |
| | 34 | 55.08 | 7.491 | 1.678 | 55.34 |
| | 35 | −32.95 | 0.500 | — | — |
| | 36 | 104.59 | 8.845 | 1.439 | 94.66 |
| | 37 | −32.20 | 0.500 | — | — |
| | 38 | 73.66 | 6.492 | 1.497 | 81.55 |
| | 39 | −107.59 | 5.000 | — | — |
| | 40 | ∞ | 37.00 | 1.516 | 64.14 |
| | 41 | ∞ | 19.500 | 1.841 | 24.56 |
| | 42 | ∞ | 10.620 | — | — |

(B)

| | Surface Number | | | | | | | |
|---|---|---|---|---|---|---|---|---|
| | 3 | 5 | 6 | 16 | 17 | 18 | 19 | 25 |
| r | 149.35 | 35.19 | 14.72 | 27.65 | 184.46 | 57.12 | 12.04 | −39.68 |
| k | 4.21525 | 0.00000 | −0.65339 | 0.00000 | 0.00000 | 0.00000 | −0.62839 | 0.00000 |
| B4 | 1.54410E−05 | 3.42333E−07 | −4.72924E−05 | −6.05245E−06 | 4.74855E−06 | 2.83476E−05 | −9.51802E−05 | 2.34201E−06 |
| B6 | −2.45093E−08 | 8.05752E−08 | 3.82038E−07 | −1.07238E−08 | −3.48077E−08 | −3.16489E−07 | 1.45068E−07 | 7.12962E−10 |
| B8 | 3.19689E−11 | −2.55523E−10 | −1.33504E−09 | −9.32882E−12 | 8.18481E−11 | 1.39135E−09 | −3.49355E−10 | 3.93659E−14 |
| B10 | −2.64430E−14 | 3.88938E−13 | 9.39734E−13 | 2.64352E−15 | −1.15043E−13 | −2.83461E−12 | 5.50468E−13 | 5.70452E−16 |
| B12 | 1.29527E−17 | −2.55966E−16 | 1.57525E−15 | −7.87783E−18 | 7.24481E−17 | 2.30650E−15 | −1.50234E−15 | 0.00000E+00 |
| B14 | −2.76965E−21 | 0.00000E+00 | −2.09038E−18 | 0.00000E+00 | 0.00000E+00 | 0.00000E+00 | 0.00000E+00 | 0.00000E+00 |
| B16 | 0.00000E+00 | 0.00000E+00 | 0.00000E+00 | 0.00000E+00 | 0.00000E+00 | 0.00000E+00 | 0.00000E+00 | 0.00000E+00 |

(C)

| | Surface Interval d[mm] | | | | | |
|---|---|---|---|---|---|---|
| | Wide-Angle End | | | Telephoto End | | |
| Surface | Distance L | | | | | |
| Number | 459 | 655 | 1965 | 459 | 655 | 1965 |
| 2 | 16.414 | 16.616 | 16.952 | 16.414 | 16.616 | 16.952 |
| 13 | 8.347 | 8.309 | 8.237 | 8.247 | 8.309 | 8.237 |
| 15 | 0.928 | 0.765 | 0.500 | 0.928 | 0.765 | 0.500 |
| 19 | 25.059 | 25.059 | 25.059 | 19.215 | 19.215 | 19.215 |
| 21 | 7.544 | 7.544 | 7.544 | 1.407 | 1.407 | 1.407 |
| 23 | 6.300 | 6.300 | 6.300 | 14.018 | 14.018 | 14.018 |
| 25 | 30.292 | 30.292 | 30.292 | 34.556 | 34.556 | 34.556 |

TABLE 2
(A)

| | | Wide-Angle End | | Telephoto End | |
|---|---|---|---|---|---|
| f | | −5.69 | | −6.26 | |
| Fno | | 2.40 | | 2.40 | |
| ω | | 66.37 | | 64.33 | |
| Zoom Ratio | | 1.10 | | | |
| | Surface | Paraxial Curvature | Surface Interval | Refractive | Abbe |
| | Number | Radius r[mm] | d[mm] | Index n | Number ν |
| ※ | 1 | 71.72 | 2.000 | 1.772 | 49.60 |
| | 2 | 35.00 | Variable | — | — |
| ※ | 3 | 68.79 | 4.021 | 1.583 | 59.39 |
| ※ | 4 | 14.66 | 20.859 | — | — |
| | 5 | −26.19 | 2.057 | 1.847 | 23.78 |
| | 6 | 36.08 | 4.565 | 1.593 | 68.62 |
| | 7 | −17.60 | 0.500 | — | — |
| | 8 | 63.54 | 6.012 | 1.816 | 46.62 |
| | 9 | −18.49 | 2.000 | 1.847 | 23.78 |
| | 10 | 34.25 | 5.773 | 1.593 | 68.62 |
| | 11 | −82.94 | Variable | — | — |
| | 12 | 100.22 | 9.348 | 1.808 | 22.76 |
| | 13 | −47.91 | Variable | — | — |
| ※ | 14 | 27.20 | 10.000 | 1.851 | 37.10 |
| ※ | 15 | 281.99 | Variable | — | — |
| ※ | 16 | −78.60 | 4.500 | 1.583 | 59.39 |
| ※ | 17 | 15.18 | Variable | — | — |
| | 18 | −87.32 | 6.847 | 1.657 | 48.33 |
| | 19 | −33.89 | Variable | — | — |
| | 20 | −24.45 | 9.500 | 1.883 | 40.77 |
| | 21 | −30.55 | Variable | — | — |
| ※ | 22 | 53.00 | 10.597 | 1.583 | 59.39 |
| ※ | 23 | −176.68 | Variable | — | — |
| ST | 24 | ∞ | 12.214 | — | — |
| | 25 | 38.13 | 2.000 | 1.750 | 35.33 |
| | 26 | 13.51 | 6.690 | 1.808 | 22.76 |
| | 27 | 53.60 | 8.416 | — | — |
| | 28 | −25.84 | 2.000 | 1.847 | 23.78 |
| | 29 | 45.32 | 6.756 | 1.642 | 58.37 |
| | 30 | −19.98 | 3.714 | — | — |
| | 31 | −17.65 | 2.000 | 1.916 | 31.60 |
| | 32 | −953.83 | 5.309 | 1.697 | 55.53 |
| | 33 | −29.14 | 0.500 | — | — |
| | 34 | 375.33 | 8.290 | 1.439 | 94.56 |
| | 35 | −35.40 | 0.500 | — | — |
| | 36 | 54.55 | 7.309 | 1.497 | 81.55 |
| | 37 | −107.69 | 5.000 | — | — |
| | 38 | ∞ | 37.000 | 1.516 | 64.14 |
| | 39 | ∞ | 19.500 | 1.841 | 24.56 |
| | 40 | ∞ | 10.120 | — | — |

(B)

| | Surface Number | | | | | |
|---|---|---|---|---|---|---|
| | 1 | 3 | 4 | 14 | 15 | 16 |
| r | 71.72 | 68.79 | 14.66 | 27.70 | 281.99 | −78.60 |
| k | 0.00000 | 0.00000 | −0.66015 | 0.00000 | 0.00000 | 0.00000 |
| B4 | 1.34349E−06 | 2.07806E−05 | −4.32193E−05 | −8.43849E−06 | 6.59825E−06 | −4.60342E−05 |
| B6 | 1.23720E−11 | −2.44683E−08 | 2.77309E−07 | −8.68969E−10 | −1.22493E−08 | 1.58241E−08 |
| B8 | −2.97885E−13 | 1.93963E−11 | −1.35302E−09 | −3.39357E−11 | −7.37415E−12 | 1.00462E−09 |
| B10 | 2.22518E−16 | 7.08097E−15 | 2.33529E−12 | 3.40109E−14 | 0.00000E+00 | −4.23297E−12 |
| B12 | −4.00745E−20 | −2.19914E−17 | −1.52309E−15 | −7.51111E−17 | 0.00000E+00 | 5.60174E−15 |
| B14 | 0.00000E+00 | 0.00000E+00 | 0.00000E+00 | 0.00000E+00 | 0.00000E+00 | 0.00000E+00 |
| B16 | 0.00000E+00 | 0.00000E+00 | 0.00000E+00 | 0.00000E+00 | 0.00000E+00 | 0.00000E+00 |
| | | | | Surface Number | | |
| | | | | 17 | 22 | 23 |
| | | | r | 15.18 | 53.00 | −176.68 |
| | | | k | −0.70173 | 0.00000 | 0.00000 |
| | | | B4 | −1.60733E−04 | 2.13753E−07 | 1.61118E−06 |
| | | | B6 | 6.25308E−07 | 3.87333E−09 | 4.95785E−08 |
| | | | B8 | −1.80716E−09 | −1.22342E−11 | −1.74645E−11 |
| | | | B10 | 2.82705E−12 | 2.03316E−14 | 3.54838E−14 |
| | | | B12 | −1.80002E−15 | −1.5292E−17 | −3.84073E−17 |
| | | | B14 | 0.00000E+00 | 0.00000E+00 | 1.33563E−20 |
| | | | B16 | 0.00000E+00 | 0.00000E+00 | 0.00000E+00 |

(C)

| | Surface Interval d[mm] | | | | | |
|---|---|---|---|---|---|---|
| | Wide-Angle End | | | Telephoto End | | |
| Surface | Distance L | | | | | |
| Number | 542 | 775 | 2325 | 542 | 775 | 2325 |
| 2 | 12.134 | 12.300 | 12.600 | 12.134 | 12.300 | 12.600 |
| 11 | 7.593 | 7.534 | 7.486 | 7.593 | 7.534 | 7.486 |
| 13 | 0.848 | 0.751 | 0.500 | 0.848 | 0.751 | 0.500 |
| 15 | 19.408 | 19.397 | 19.396 | 19.144 | 19.134 | 19.133 |
| 17 | 10.070 | 10.070 | 10.070 | 12.852 | 12.852 | 12.852 |
| 19 | 29.398 | 29.398 | 29.398 | 6.023 | 6.023 | 6.023 |
| 21 | 0.500 | 0.500 | 0.500 | 20.447 | 20.447 | 20.447 |
| 23 | 54.775 | 54.775 | 54.775 | 56.685 | 55.685 | 55.685 |

TABLE 3
(A)

| | | Wide-Angle End | | Telephoto End | |
|---|---|---|---|---|---|
| f | | −8.51 | | −10.73 | |
| Fno | | 2.40 | | 2.54 | |
| ω | | 56.88 | | 50.61 | |
| Zoom Ratio | | 1.26 | | | |
| | Surface | Paraxial Curvature | Surface Interval | Refractive | Abbe |
| | Number | Radius r[mm] | d[mm] | Index n | Number ν |
| | 1 | 42.55 | 2.000 | 1.806 | 40.93 |
| | 2 | 30.25 | Variable | — | — |
| ※ | 3 | 40.45 | 2.000 | 1.583 | 59.39 |
| ※ | 4 | 12.91 | 19.286 | — | — |
| | 5 | −15.93 | 2.000 | 1.808 | 22.76 |
| | 6 | 84.98 | 4.739 | 1.593 | 68.62 |
| | 7 | −14.84 | 0.500 | — | — |
| | 8 | 165.18 | 5.715 | 1.892 | 37.13 |
| | 9 | −15.38 | 2.000 | 1.847 | 23.78 |
| | 10 | 40.01 | 5.883 | 1.593 | 68.62 |
| | 11 | −35.79 | Variable | — | — |
| | 12 | 90.70 | 7.986 | 1.808 | 22.76 |
| | 13 | −119.88 | Variable | — | — |
| ※ | 14 | 27.59 | 10.318 | 1.861 | 37.10 |
| ※ | 15 | 86.82 | 30.935 | — | — |
| ※ | 16 | 49.01 | 2.367 | 1.808 | 40.55 |
| ※ | 17 | 12.58 | Variable | — | — |
| | 18 | −138.77 | 5.801 | 1.916 | 31.60 |
| | 19 | −27.41 | Variable | — | — |
| | 20 | −20.27 | 9.011 | 1.772 | 49.60 |
| | 21 | −25.10 | Variable | — | — |
| | 22 | 87.00 | 4.529 | 1.835 | 42.74 |
| | 23 | −414.19 | Variable | — | — |
| | 24 | 40.18 | 2.002 | 1.852 | 40.78 |
| | 25 | 21.10 | 4.833 | 1.946 | 17.98 |
| | 26 | 33.61 | Variable | — | — |
| ST | 27 | ∞ | 3.194 | — | — |
| | 28 | −329.43 | 2.000 | 1.847 | 23.78 |
| | 29 | 29.21 | 6.625 | 1.678 | 55.34 |
| | 30 | −64.59 | 4.932 | — | — |
| | 31 | −27.49 | 2.000 | 1.855 | 24.80 |
| | 32 | 79.77 | 8.424 | 1.623 | 58.17 |
| | 33 | −33.52 | 0.500 | — | — |
| | 34 | 89.56 | 9.102 | 1.439 | 94.66 |
| | 35 | −42.88 | Variable | — | — |
| | 36 | 58.51 | 5.292 | 1.497 | 81.55 |
| | 37 | 213.32 | 5.000 | — | — |
| | 38 | ∞ | 37.000 | 1.516 | 64.14 |
| | 39 | ∞ | 19.500 | 1.841 | 24.56 |
| | 40 | ∞ | 11.560 | — | — |

(B)

| | Surface Number | | | | | |
|---|---|---|---|---|---|---|
| | 3 | 4 | 14 | 15 | 16 | 17 |
| r | 40.45 | 12.91 | 27.59 | 86.82 | 49.01 | 12.58 |
| k | 0.00000 | −0.55092 | 0.00000 | 0.00000 | 0.00000 | −1.05348 |
| B4 | 3.00636E−05 | −2.68398E−05 | −5.72942E−06 | −2.24617E−16 | −1.25823E−04 | −1.68721E−04 |
| B6 | −7.00024E−08 | 4.06663E−08 | −3.66132E−10 | 1.08983E−08 | 4.17605E−07 | 7.08459E−07 |
| B8 | 2.93783E−10 | −4.96077E−11 | −3.14018E−12 | −1.94537E−11 | −6.90436E−10 | −1.34338E−09 |
| B10 | −6.04820E−13 | −1.34360E−12 | −3.15566E−15 | 2.04614E−14 | 0.00000E+00 | 0.00000E+00 |
| B12 | 6.85884E−16 | 0.00000E+00 | 0.00000E+00 | 0.00000E+00 | 0.00000E+00 | 0.00000E+00 |
| B14 | 0.00000E+00 | 0.00000E+00 | 0.00000E+00 | 0.00000E+00 | 0.00000E+00 | 0.00000E+00 |
| B16 | 0.00000E+00 | 0.00000E+00 | 0.00000E+00 | 0.00000E+00 | 0.00000E+00 | 0.00000E+00 |

(C)

| | Surface Interval d[mm] | | | | | |
|---|---|---|---|---|---|---|
| | Wide-Angle End | | | Telephoto End | | |
| Surface | Distance L | | | | | |
| Number | 697 | 1163 | 3489 | 697 | 1163 | 3489 |
| 2 | 21.839 | 22.112 | 22.391 | 21.839 | 22.112 | 22.391 |
| 11 | 23.737 | 23.713 | 23.687 | 23.737 | 23.713 | 23.687 |
| 13 | 1.105 | 0.857 | 0.603 | 1.105 | 0.867 | 0.603 |
| 17 | 12.764 | 12.764 | 12.764 | 13.028 | 13.028 | 13.028 |
| 19 | 10.189 | 10.189 | 10.189 | 8.143 | 8.143 | 8.149 |
| 21 | 19.804 | 19.804 | 19.804 | 1.000 | 1.000 | 1.000 |
| 23 | 14.933 | 14.933 | 14.933 | 30.348 | 30.348 | 30.348 |
| 26 | 10.156 | 10.156 | 10.156 | 4.917 | 4.917 | 4.917 |
| 35 | 0.500 | 0.500 | 0.500 | 10.910 | 10.910 | 10.910 |

TABLE 4
(A)

| | Wide-Angle End | Telephoto End |
|---|---|---|
| f | −10.54 | −15.80 |
| Fno | 2.40 | 2.60 |
| ω | 51.09 | 39.62 |

| Zoom Ratio | 1.50 | | | | |
|---|---|---|---|---|---|
| | Surface | Paraxial Curvature | Surface Interval | Refractive | Abbe |
| | Number | Radius r[mm] | d[mm] | Index n | Number ν |
| ※ | 1 | 50.98 | 3.321 | 1.583 | 59.39 |
| ※ | 2 | 13.00 | 19.329 | — | — |
| | 3 | −17.36 | 4.968 | 1.808 | 22.76 |
| | 4 | 72.70 | 4.848 | 1.593 | 68.62 |
| | 5 | −17.52 | 0.500 | — | — |
| | 6 | 638.02 | 4.930 | 1.883 | 40.77 |
| | 7 | −21.57 | 2.000 | 1.847 | 23.78 |
| | 8 | 63.95 | 5.739 | 1.593 | 68.62 |
| | 9 | −29.60 | Variable | — | — |
| | 10 | 99.62 | 8.369 | 1.808 | 22.76 |
| | 11 | −99.42 | Variable | — | — |
| ※ | 12 | 28.80 | 9.500 | 1.861 | 37.10 |
| ※ | 13 | 47.25 | 33.980 | — | — |
| ※ | 14 | 35.33 | 3.908 | 1.808 | 40.55 |
| ※ | 15 | 12.03 | Variable | — | — |
| | 16 | −222.76 | 9.061 | 1.892 | 37.13 |
| | 17 | −28.08 | Variable | — | — |
| | 18 | −28.58 | 7.844 | 1.497 | 81.55 |
| | 19 | −31.37 | Variable | — | — |
| | 20 | 76.97 | 4.863 | 1.697 | 55.53 |
| | 21 | −213.57 | Variable | — | — |
| | 22 | 29.96 | 2.000 | 1.892 | 37.13 |
| | 23 | 16.66 | 5.110 | 1.946 | 17.98 |
| | 24 | 24.45 | Variable | — | — |
| ST | 25 | ∞ | 3.980 | — | — |
| | 26 | −46.94 | 2.000 | 1.847 | 23.78 |
| | 27 | 29.46 | 6.355 | 1.603 | 60.64 |
| | 28 | −34.87 | 4.404 | — | — |
| | 29 | −22.70 | 2.000 | 1.916 | 31.60 |
| | 30 | 151.37 | 7.823 | 1.764 | 48.49 |
| | 31 | −28.91 | 0.500 | — | — |
| | 32 | 104.94 | 8.875 | 1.439 | 94.66 |
| | 33 | −38.59 | Variable | — | — |
| | 34 | 60.25 | 9.500 | 1.497 | 81.55 |
| | 35 | 1078.08 | 5.000 | — | — |
| | 36 | ∞ | 37.000 | 1.516 | 64.14 |
| | 37 | ∞ | 19.500 | 1.841 | 24.56 |
| | 38 | ∞ | 11.940 | — | — |

(B)

| | Surface Number | | | | | |
|---|---|---|---|---|---|---|
| | 1 | 2 | 12 | 13 | 14 | 15 |
| r | 50.98 | 13.00 | 28.80 | 47.25 | 35.33 | 12.03 |
| k | 0.00000 | −0.57804 | 0.00000 | 0.00000 | 0.00000 | −1.12015 |
| B4 | 7.26364E−06 | −2.87844E−05 | −4.30723E−06 | −4.61332E−06 | −1.21765E−04 | −1.62617E−04 |
| B6 | 1.32443E−08 | 4.87171E−08 | 2.38273E−09 | 1.93888E−08 | 2.59278E−07 | 6.14843E−07 |
| B8 | −3.15997E−11 | 4.41349E−10 | −2.62989E−13 | −1.70375E−11 | −3.60425E−10 | −1.42314E−09 |
| B10 | 3.59509E−14 | −2.49469E−12 | 1.28324E−16 | 1.43948E−14 | 0.00000E+00 | 1.47128E−12 |
| B12 | −9.34466E−18 | 0.00000E+00 | 0.00000E+00 | 0.00000E+00 | 0.00000E+00 | 0.00000E+00 |
| B14 | 0.00000E+00 | 0.00000E+00 | 0.00000E+00 | 0.00000E+00 | 0.00000E+00 | 0.00000E+00 |
| B16 | 0.00000E+00 | 0.00000E+00 | 0.00000E+00 | 0.00000E+00 | 0.00000E+00 | 0.00000E+00 |

(C)

| | Surface Interval d[mm] | | | | | |
|---|---|---|---|---|---|---|
| | Wide-Angle End | | | Telephoto End | | |
| Surface | Distance L | | | | | |
| Number | 700 | 1463 | 4393 | 700 | 1463 | 4393 |
| 9 | 19.053 | 18.932 | 18.861 | 19.053 | 18.932 | 18.861 |
| 11 | 2.201 | 1.858 | 1.645 | 2.201 | 1.858 | 1.645 |
| 15 | 12.081 | 12.081 | 12.081 | 11.758 | 11.758 | 11.758 |
| 17 | 40.717 | 40.717 | 40.717 | 7.180 | 7.180 | 7.180 |
| 19 | 1.500 | 1.500 | 1.500 | 1.502 | 1.502 | 1.502 |
| 21 | 1.000 | 1.000 | 1.000 | 27.209 | 27.209 | 27.209 |
| 24 | 10.944 | 10.944 | 10.944 | 5.121 | 5.121 | 5.121 |
| 33 | 2.112 | 2.112 | 2.112 | 15.584 | 15.584 | 15.584 |

TABLE 5
(A)

| | | Wide-Angle End | | Telephoto End | |
|---|---|---|---|---|---|
| f | | −8.39 | | −11.74 | |
| Fno | | 2.40 | | 2.58 | |
| ω | | 57.28 | | 48.10 | |
| Zoom Ratio | | 1.40 | | | |
| | Surface | Paraxial Curvature | Surface Interval | Refractive | Abbe |
| | Number | Radius r[mm] | d[mm] | Index n | Number ν |
| ※ | 1 | 76.23 | 3.599 | 1.583 | 59.39 |
| ※ | 2 | 12.67 | 17.411 | — | — |
| | 3 | −21.11 | 2.946 | 1.808 | 22.76 |
| | 4 | 37.13 | 4.667 | 1.595 | 67.74 |
| | 5 | −16.45 | 0.500 | — | — |
| | 6 | 1294.61 | 5.859 | 1.816 | 46.62 |
| | 7 | −13.99 | 2.000 | 1.855 | 24.80 |
| | 8 | 49.16 | 6.327 | 1.595 | 67.74 |
| | 9 | −30.49 | 15.084 | — | — |
| | 10 | 435.11 | 8.721 | 1.808 | 22.76 |
| | 11 | −46.08 | Variable | — | — |
| ※ | 12 | 27.40 | 8.983 | 1.861 | 37.10 |
| ※ | 13 | 66.79 | 31.606 | — | — |
| ※ | 14 | 45.99 | 3.975 | 1.808 | 40.55 |
| ※ | 15 | 11.78 | 12.938 | — | — |
| | 16 | −176.73 | 9.322 | 1.883 | 40.77 |
| | 17 | −27.40 | Variable | — | — |
| | 18 | −22.50 | 3.057 | 1.487 | 70.24 |
| | 19 | −23.82 | Variable | — | — |
| | 20 | 100.21 | 4.409 | 1.772 | 49.60 |
| | 21 | −283.91 | Variable | — | — |
| | 22 | 34.25 | 2.057 | 1.850 | 30.05 |
| | 23 | 18.96 | 6.587 | 1.946 | 17.98 |
| | 24 | 27.97 | Variable | — | — |
| ST | 25 | ∞ | 4.205 | — | — |
| | 26 | −48.70 | 2.811 | 1.855 | 24.80 |
| | 27 | 32.09 | 8.027 | 1.678 | 55.34 |
| | 28 | −34.16 | 4.266 | — | — |
| | 29 | −23.89 | 2.000 | 1.850 | 30.05 |
| | 30 | 175.60 | 8.122 | 1.717 | 47.93 |
| | 31 | −35.53 | 0.500 | — | — |
| | 32 | 110.30 | 9.641 | 1.439 | 94.66 |
| | 33 | −42.12 | Variable | — | — |
| | 34 | 57.51 | 6.946 | 1.497 | 81.55 |
| | 35 | 295.76 | 5.000 | — | — |
| | 36 | ∞ | 37.000 | 1.516 | 64.14 |
| | 37 | ∞ | 19.500 | 1.841 | 24.56 |
| | 38 | ∞ | 11.442 | — | — |

(B)

| | Surface Number | | | | | |
|---|---|---|---|---|---|---|
| | 1 | 2 | 12 | 13 | 14 | 15 |
| r | 76.23 | 12.67 | 27.40 | 66.79 | 45.99 | 11.78 |
| k | 0.00000 | −0.62186 | 0.00000 | 0.00000 | 0.00000 | −1.09333 |
| B4 | 2.32213E−05 | −2.43449E−05 | −7.06377E−06 | −5.64498E−06 | −1.02812E−04 | −1.61697E−04 |
| B6 | −4.35416E−08 | 1.38363E−07 | 5.75505E−10 | 1.95125E−08 | 2.15525E−07 | 6.18210E−07 |
| B8 | 8.35930E−11 | −3.92813E−10 | −3.27194E−12 | −2.53883E−11 | −3.16535E−10 | −1.49735E−09 |
| B10 | −9.14319E−14 | −7.65925E−13 | 1.59823E−15 | 2.75263E−14 | 0.00000E+00 | 1.63527E−12 |
| B12 | 5.29401E−17 | 0.00000E+00 | 0.00000E+00 | 0.00000E+00 | 0.00000E+00 | 0.00000E+00 |
| B14 | 0.00000E+00 | 0.00000E+00 | 0.00000E+00 | 0.00000E+00 | 0.00000E+00 | 0.00000E+00 |
| B16 | 0.00000E+00 | 0.00000E+00 | 0.00000E+00 | 0.00000E+00 | 0.00000E+00 | 0.00000E+00 |

(C)

| | Surface Interval d[mm] | | | | | |
|---|---|---|---|---|---|---|
| | Wide-Angle End | | | Telephoto End | | |
| Surface | Distance L | | | | | |
| Number | 700 | 1163 | 3493 | 700 | 1163 | 3493 |
| 11 | 5.372 | 5.116 | 4.855 | 5.372 | 5.116 | 4.855 |
| 17 | 54.700 | 54.700 | 54.700 | 25.500 | 25.500 | 25.500 |
| 19 | 6.820 | 6.820 | 6.820 | 1.000 | 1.000 | 1.000 |
| 21 | 1.780 | 1.780 | 1.780 | 31.700 | 31.700 | 31.700 |
| 24 | 12.516 | 12.516 | 12.516 | 5.057 | 5.057 | 5.057 |
| 33 | 2.500 | 2.500 | 2.500 | 14.121 | 14.121 | 14.121 |

### [Image Projection Apparatus]

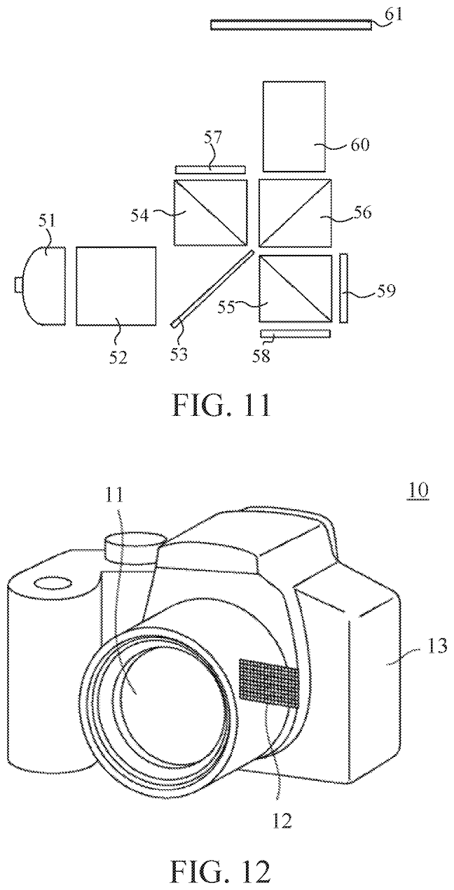

FIG. 11 is a schematic diagram of an image projection apparatus having the optical system 100 of the present invention as a projection optical system. An illumination optical system 52 has a function of realizing illumination with less unevenness with respect to the light modulation element. A color separation optical system 53 separates the light from the illumination optical system 52 into an arbitrary color corresponding to the light modulation element. Polarization beam splitters 54 and 55 transmit or reflect the incident light. Reflective image display elements 57, 58, and 59 modulate the incident light according to an electric signal. A color combining optical system 56 combines the light from each light modulation elements into one. A projection optical system 60 includes the optical system 100 of the present invention, and projects the light combined by the color combining optical system 56 onto the projection surface such as a screen 61. The illumination optical system 52, the color separation optical system 53, the polarization beam splitters 54 and 55, and the color combining optical system 56 are light guiding optical systems for guiding the light from a light source 51 to the image display element.

Although an apparatus using three reflective image display elements has been shown as an example of the image projection apparatus, the present invention is not limited to this.

### [Image Pickup Apparatus]

Next, referring now to FIG. 12, a description will be given of a digital still camera (image pickup apparatus) using the optical system 100 of the present invention as an image pickup optical system. In FIG. 12, reference numeral 10 denotes a camera body, and reference numeral 11 denotes a photographing optical system configured by any one of the optical systems described in the first to fifth embodiments. Reference numeral 12 denotes a solid-state image sensor (photoelectric conversion element) such as a CCD sensor or a CMOS sensor which is built in the camera body and receives an optical image formed by the photographing optical system 11 and photoelectrically converts it. The camera body 10 may be a so-called single lens reflex camera having a quick return mirror or a so-called mirrorless camera having no quick return mirror.

By thus applying the optical system of the present invention to an image pickup apparatus such as a digital still camera, an image pickup apparatus having a wide angle and a small lens can be obtained.

### [Imaging System]

An imaging system (surveillance camera system) including the zoom lens of each embodiment and a control unit that controls the zoom lens may be configured. In this case, the control unit can control the zoom lens so that each lens unit moves as described above during zooming and focusing. At this time, the control unit does not have to be configured integrally with the zoom lens and may be configured separately from the zoom lens. For example, a configuration may be adopted in which a control unit (control device) arranged far from a drive unit that drives each lens of the zoom lens includes a transmission unit that sends a control signal (command) for controlling the zoom lens. With such a control unit, the zoom lens can be operated remotely.

Further, a configuration may be adopted in which an operating unit such as a controller or a button for remotely operating the zoom lens is provided in the control unit to control the zoom lens according to an input to the operating unit by the user. For example, an enlargement button and a reduction button are provided as the operation unit, and the control unit may send a signal to the drive unit of the zoom lens so that the zoom lens magnification is increased when the user presses the enlargement button and the zoom lens magnification is reduced when the user presses the reduction button.

Further, the imaging system may have a display unit such as a liquid crystal panel that displays information (moving state) regarding zooming of the zoom lens. The information regarding the zooming of the zoom lens is, for example, the zoom magnification (zoom state) and the movement amount (movement state) of each lens unit. In this case, the user can remotely operate the zoom lens via the operation unit while viewing the information regarding the zooming of the zoom lens displayed on the display unit. At this time, the display unit and the operation unit may be integrated by adopting, for example, a touch panel.

According to the above-described embodiment, it is possible to provide an imaging optical system that has a wide angle and a small lens diameter and that has good optical performance in a wide projection distance range.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-190314, filed on Oct. 17, 2019 which is hereby incorporated by reference herein in its entirety.

What is claimed is:

1. An imaging optical system comprising, in order from an enlargement conjugate side to a reduction conjugate side, a first optical system having a positive refractive power, and a second optical system having a positive refractive power,
wherein an enlargement conjugate point on the enlargement conjugate side is imaged on an intermediate imaging position between the first optical system and the second optical system,
wherein an image imaged on the intermediate imaging position is reimaged on a reduction conjugate point on the reduction conjugate side,
wherein the first optical system includes a first lens unit disposed closest to the enlargement conjugate side among lens units that moves in an optical axis direction of the imaging optical system during focusing,
wherein the second optical system includes at least one lens unit that is fixed during focusing and that moves in the optical axis direction during zooming,
wherein the first lens unit includes a meniscus lens that is disposed closest to the enlargement conjugate side and that has a negative refractive power,
wherein the meniscus lens has an aspheric surface, and
wherein the meniscus lens is convex to the enlargement conjugate side.

2. The imaging optical system according to claim 1,
wherein the first optical system includes a first lens disposed closer to the reduction conjugate side than the meniscus lens, and
wherein the following conditional expression is satisfied:
0<v≤40
where v is an Abbe number of the first lens.

3. The imaging optical system according to claim 2, wherein a principal ray of an off-axis ray intersects an optical axis of the imaging optical system between the meniscus lens and the first lens.

4. The imaging optical system according to claim 2, wherein the first lens is a single lens.

5. The imaging optical system according to claim 2, wherein the first lens has a positive refractive power.

6. The imaging optical system according to claim 2, wherein the following conditional expression is satisfied:
−1≤f₂/f₁≤1
where f₁ is a focal length of an optical system from the meniscus lens to the first lens, and f₂ is a focal length of the first lens.

7. The imaging optical system according to claim 1, wherein the first lens unit includes a cemented lens.

5. The imaging optical system according to claim 7, wherein the cemented lens includes three single lenses.

9. The imaging optical system according to claim 8, wherein the cemented lens includes, in order from the enlargement conjugate side to the reduction conjugate side, a biconvex lens, a biconcave lens, and a biconvex lens.

10. The imaging optical system according to claim wherein the following conditional expression is satisfied:
v₁₂<v₁₁
v₁₂<v₁₃
v₁₁<v₁₃
where v₁₁, v₁₂, and v₁₃ are, in order from the enlargement conjugate side, Abbe numbers of the three single lenses.

11. The imaging optical system according to claim 1, wherein the first optical system includes one moving lens unit that moves in the optical axis direction during focusing.

12. The imaging optical system according to claim 1, wherein the first optical system includes two moving lens units that move in the optical axis direction during focusing.

13. The imaging optical system according to claim 1, wherein the first optical system includes three moving lens units that move in the optical axis direction during focusing.

14. The imaging optical system according to claim 12, wherein a lens unit different from the first lens unit among the moving lens units has a positive refractive power.

15. An image projection apparatus comprising:
a light modulation element; and
an imaging optical system comprising, in order from an enlargement conjugate side to a reduction conjugate side, a first optical system having a positive refractive power, and a second optical system having a positive refractive power,
wherein an enlargement conjugate point on the enlargement conjugate side is imaged on an intermediate imaging position between the first optical system and the second optical system,
wherein an image imaged on the intermediate imaging position is reimaged on a reduction conjugate point on the reduction conjugate side,
wherein the first optical system includes a first lens unit disposed closest to the enlargement conjugate side among lens units that moves in an optical axis direction of the imaging optical system during focusing,
wherein the second optical system includes at least one lens unit that is fixed during focusing and that moves in the optical axis direction during zooming,
wherein the first lens unit includes a meniscus lens that is disposed closest to the enlargement conjugate side and that has a negative refractive power,
wherein the meniscus lens has an aspheric surface, and
wherein the meniscus lens is convex to the enlargement conjugate side.
